(19) United States
(12) Patent Application Publication
(10) Pub. No.: US 2011/0127143 A1
(43) Pub. Date: Jun. 2, 2011

(54) CONTAINER TRANSFER DEVICE INCLUDING AN ADJUSTABLE PERIPHERAL GUIDE

(75) Inventors: Michele Calzolari, Octeville-Sur-Mer (IT); Gianluca Dall'Ast, Octeville-Sur-Mer (IT)

(73) Assignee: SIDEL PARTICIPATIONS, Octeville-Sur-Mer (FR)

(21) Appl. No.: 12/920,794

(22) PCT Filed: Mar. 3, 2008
(86) PCT No.: PCT/IB2008/001236

§ 371 Date: Dec. 8, 2010

(51) Int. Cl. B65G 47/00

(52) U.S. Cl. 198/618

(57) ABSTRACT

Adjustable device for transferring containers along an arc-of-a-circle path (6) from a loading point to a discharge point, comprising an adjustable curved guide (16) including a series of guiding segments (20) located adjacent to each other, and an adjustment mechanism (34) for radially moving said guiding segments (20) forth or back to set a radius of the curved guide (16) to a predetermined container diameter, the adjustment mechanism (34) comprising a distribution mechanism (38) for synchronizing movement of the guiding segments (20).

### FIELD OF THE INVENTION

The invention relates to container handling, and more precisely to a device for transferring containers along an arc-of-a-circle path from a loading point to a discharge point. Such a transfer device may be located at the end of a filling machine, wherein filled and capped containers are picked up individually with a predetermined pitch and transferred e.g. to a belt conveyor to be packed for transportation.

### BACKGROUND OF THE INVENTION

Until the containers are filled, they are usually transported by the neck, which is practical (and thus favored) because although containers may have different formats their neck do not vary much in shape and dimensions.

However, once the containers are filled, transportation by the neck is not suitable any more because the weight of the poured content (e.g. a liquid) makes it difficult for neck grippers to tightly hold the containers, especially along circular transfer paths where strong centrifugal forces apply. This is why, for filled containers, transportation by the body is usually preferred.

Ordinary transfer devices usually comprise a rotary starwheel including at its periphery a series of recesses (generally of rounded shape), guide means under the form of a curved metallic rail located at the periphery of the starwheel, and a plate located in the space between the starwheel and the rail for supporting the containers by their bottom along their transfer path. One may refer to International application No. WO 97/45357 (SERAC) for further details.

Such a technology has several drawbacks, since a change of container format requires changing at least the starwheel and the guiding rails for each transfer device on the line. On the one hand, in order to cope with format changeover, container fillers should have as many different sets of starwheels and guiding rails as there are different container formats. On the other hand, format changeover requires line shutdown, for a time during which production inevitably stops.

In order to remedy these drawbacks, several solutions were proposed to make the container transfer devices adaptable to container format changeover.

In U.S. Pat. No. 7,007,793 (SIDEL), a transfer wheel is provided at its periphery with cells, and the wheel includes a device for varying the dimension of the cells to adapt them to the dimensions of the containers to be transferred. More precisely, the transfer wheel comprises two superposed ring-shaped plates provided with teeth defining guide slots, wherein the relative angular position of the plates can vary to adapt width of the guide slots.

In European Patent application No. 0 365 971 (SHIBUYA KOGYO), a rotatable body has a plurality of article receiving pockets, and an arcuate guide member arranged in surrounding relationship with the outer peripheral surface of the body. The pocket size is adjusted in accordance with the size of articles to be conveyed, and the arcuate guide member is movable in a direction substantially perpendicular to the direction in which an article travels at an article hand-off position, to allow articles to be handed over at a proper position.

In European Patent application No. 630 569 (SIMONAZZI), a star conveyor can be adapted to differently shaped containers thanks to the presence of an adjustment device including two discs provided with compartments for receiving containers. The discs are superposed to each other and a lever mechanism kinematically connects the discs to rotate them reciprocally, increasing or reducing the compartment diameter.

In European Patent application No. 422 059 (SARCMI), a radially adjustable push rod is used to distance the container from the center of a starwheel, in conjunction with a circular guide, also adjustable. More precisely, the guide is embodied in sections and there is provided a handwheel, rotation of which sets the sections closer or farther from the container and thus adapting the assembly to a new diameter.

The aforementioned solutions unquestionably represent a progress with respect of the ordinary non-adjustable transfer device. However, it is the inventors' opinion that adjustment mechanisms are not quite satisfactory, for the following reasons. First, they still require numerous operations in order to adapt the transfer device to a new container reference. Secondly, they do not cover a wide enough range of container formats. Thirdly, the existing adjustment mechanisms fail to provide sufficient precision to permit smooth movement whichever the container format. In practice, the adjustable container transfer devices are designed for a certain—narrow—range of container formats, and do not support container formats out of range (either too large or too small).

### SUMMARY OF THE INVENTION

It is therefore an object of the invention to propose an adjustable transfer device reducing the adjustment time.

It is another object of the invention to propose an adjustable transfer device increasing precision of the adjustment.

It is another object of the invention to propose an adjustable transfer device suitable for an enlarged range of container formats.

The proposed transfer device comprises a curved including a series of guiding segments located adjacent to each other, and an adjustment mechanism for radially moving said guiding segments forth or back to narrow or widen said annular space according to a predetermined container diameter, wherein the adjustment mechanism comprises a distribution mechanism for synchronizing movement of the guiding segments.

In one preferred embodiment, the distribution mechanism comprises an arcuate rack plate pivotally mounted with respect of a frame of the curved guide, and engaging a series of pinions coupled to the guiding segments.

The guiding segments may comprise at least one flange including an elongated slot provided with a rack engaged by a pinion.

The guiding segments comprise e.g. a pair of spaced apart flanges each including elongated slots provided with racks engaged by pinions provided at both ends of posts pivotally mounted to a frame of the curved guide. For example, each flange includes a pair of slots each provided with a rack.

The flanges of two adjacent guiding segments preferably overlap, in such a way that a common pinion engages simultaneously their respective racks.

In one preferred embodiment, the curved guide comprises a cylindrical wall, the radius of which is adjustable to the container format. For example, each guiding segment includes a cylindrical panel as part of the cylindrical wall.

The cylindrical panels of adjacent guiding segments are preferably crenellated and overlap, thereby insuring continuity of the cylindrical wall.

Each cylindrical panel preferably has a height corresponding to a largest available container height.

In addition, the rack plate may comprise a series of elongated slots in which upper ends of cylindrical spacers are engaged, in order to guide rotational movement of the rack plate.

The adjustment mechanism comprises e.g. a manually operable handwheel, pivotally mounted on the frame and pivotally coupled to a screw engaging a nut mounted on the rack plate, whereby rotation of the handwheel moves the rack plate with respect of the upper plate.

The above and other objects and advantages of the invention will become apparent from the detailed description of preferred embodiments, considered in conjunction with the accompanying drawings.

### BRIEF DESCRIPTION OF THE DRAWINGS

FIG. 1 is a top perspective view showing part of a container handling machine comprising a container transfer device, adjusted to a large container format.

FIG. 2 is a top planar view showing the container handling machine of FIG. 1, adjusted to the large container format.

FIG. 3 is a view similar to FIG. 1, wherein the container transfer device is adjusted to a small container format.

FIG. 4 is a view similar to FIG. 2, wherein the container transfer device is adjusted to the small container format.

FIG. 5 is a front perspective view showing an adjustable curved guide of the container transfer device.

FIG. 6 is a view similar to FIG. 5, showing the adjustable curved guide partly cut-out.

FIG. 7 is a rear perspective view showing the adjustable curved guide.

FIG. 8 is a top planar view showing the adjustable curved guide, adjusted to a large container format.

FIG. 9 is a top planar view showing the adjustable curved guide, adjusted to a small container format.

FIG. 10 is a perspective view showing a guiding segment.

FIG. 11 is a perspective view showing an adjustable star wheel of the container handling machine of FIG. 1, adjusted to a large container format.

FIG. 12 is a partly cut-out perspective view showing a detail of the adjustable star wheel of FIG. 11, adjusted to a large container format.

FIG. 13 is a top planar view showing a detail of the adjustable star wheel of FIG. 12, adjusted to a large container format.

FIG. 14 is a view similar to FIG. 12, wherein the star wheel is adjusted to a small container format.

FIG. 15 is a view similar to FIG. 13, wherein the star wheel is adjusted to a small container format.

FIG. 16 is a top perspective view showing the adjustable curved guide, associated with a discharge conveyor and an adjustable curved slide.

FIG. 17 is a top perspective view showing the adjustable curved guide associated with the adjustable curved slide.

FIG. 18 is a bottom perspective view showing the adjustable curved guide associated with the adjustable curved slide.

FIG. 19 is front planar view showing the adjustable curved guide associated with the adjustable curved slide.

### DESCRIPTION OF PREFERRED EMBODIMENTS

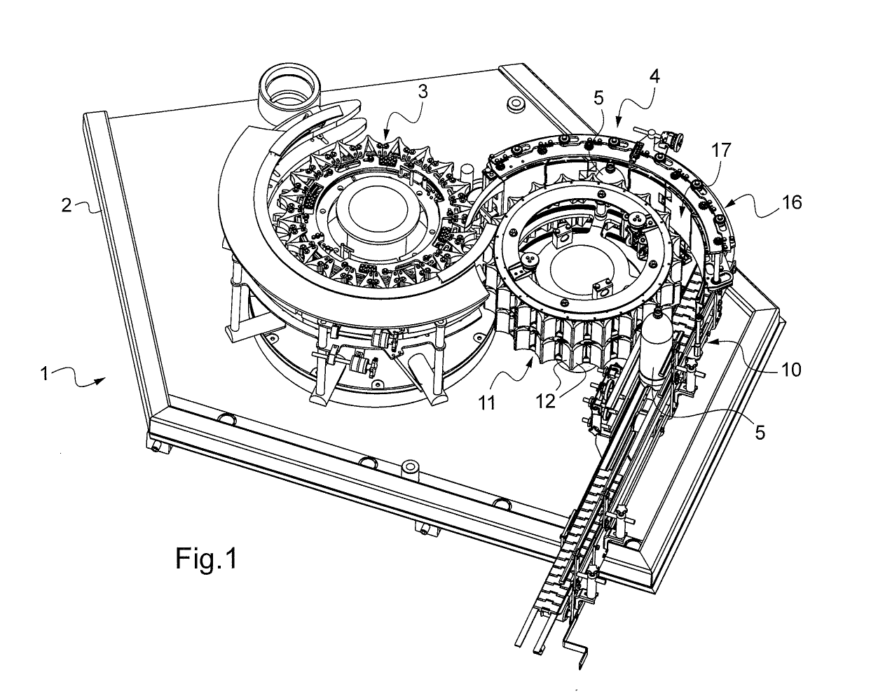

Turning now to the drawings and with more particular attention to FIG. 1, there is shown part of a container handling machine 1, e.g. a filling machine, comprising, mounted to a machine frame 2, a capping unit including a carrousel 3 provided with a plurality of container gripping elements, and a container transfer device 4, located adjacent the carrousel 3 for transferring containers 5 along an arc-of-a circle transfer path 6 from a loading point 7 located at the periphery of the carrousel 3, to a discharge point 8 located at an end 9 of a linear discharge conveyor 10.

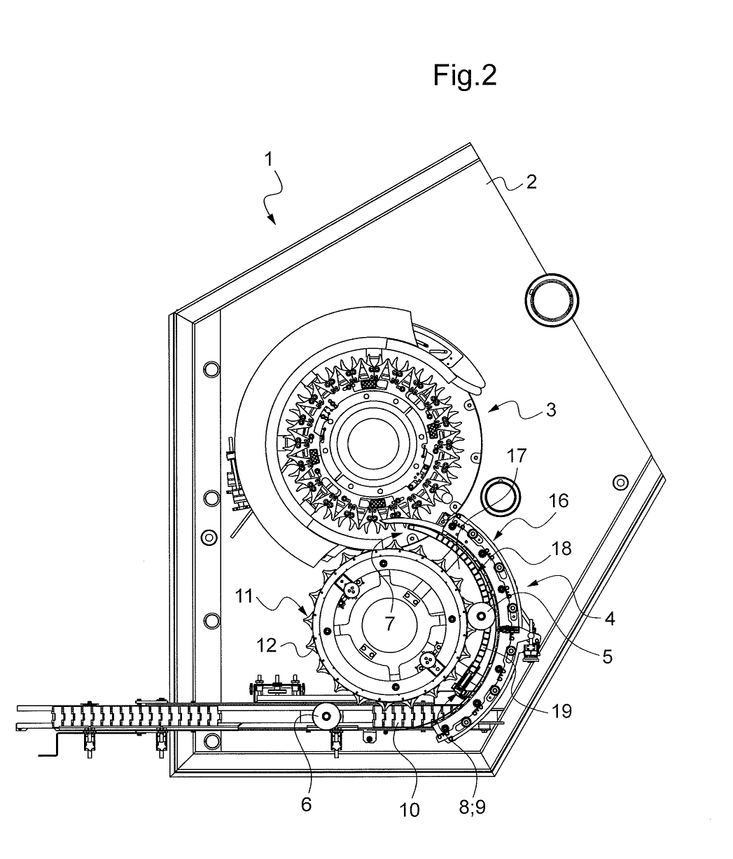

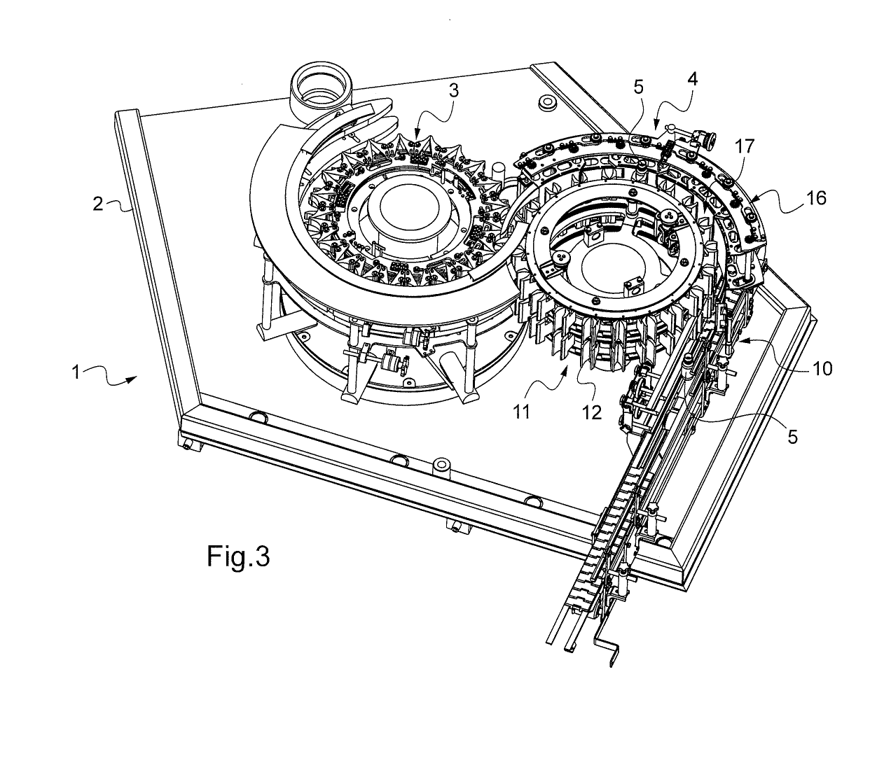

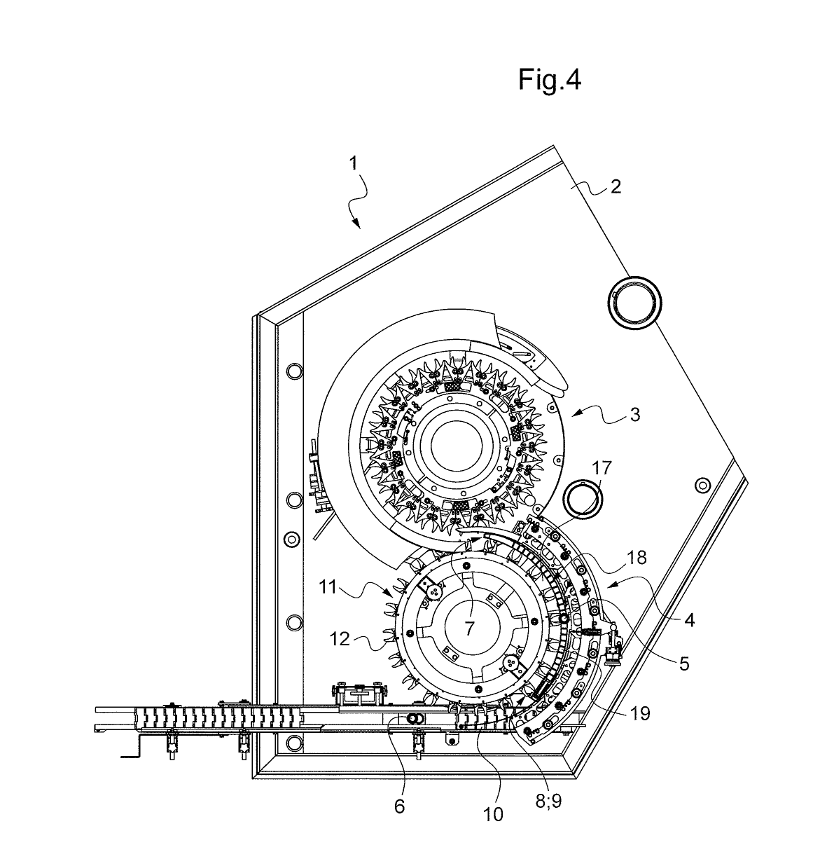

The container transfer device 4 includes an adjustable rotary star wheel 11 provided on its circumference with a plurality of gripping devices 12 each including a pair of wings 13, 14 pivotally mounted along the circular edge of the wheel 11, for engaging the containers 5 by their bodies and moving the containers 5 along the transfer path 6. The star wheel 11 includes an adjustment mechanism 15 for setting the gripping devices 12 to specific container formats (i.e. container body diameters), as depicted on FIG. 1 and FIG. 2, wherein the star wheel 11 is adjusted to a large container format, whereas on FIG. 3 and FIG. 4 it is adjusted to a small container format.

The container transfer device 4 also comprises an adjustable curved guide 16 located at the periphery of the star wheel 11 at a distance therefrom, whereby an annular space 17 is defined between the star wheel 11 and the guide 16 for permitting passage of the containers 5.

The container transfer device 4 further comprises a container support device 18, including an adjustable curved bridge 19 for supporting the containers 5 by their bottom along the transfer path 6 from the loading point 7 to the discharge point 8, whichever their format, and in particular whichever their height.

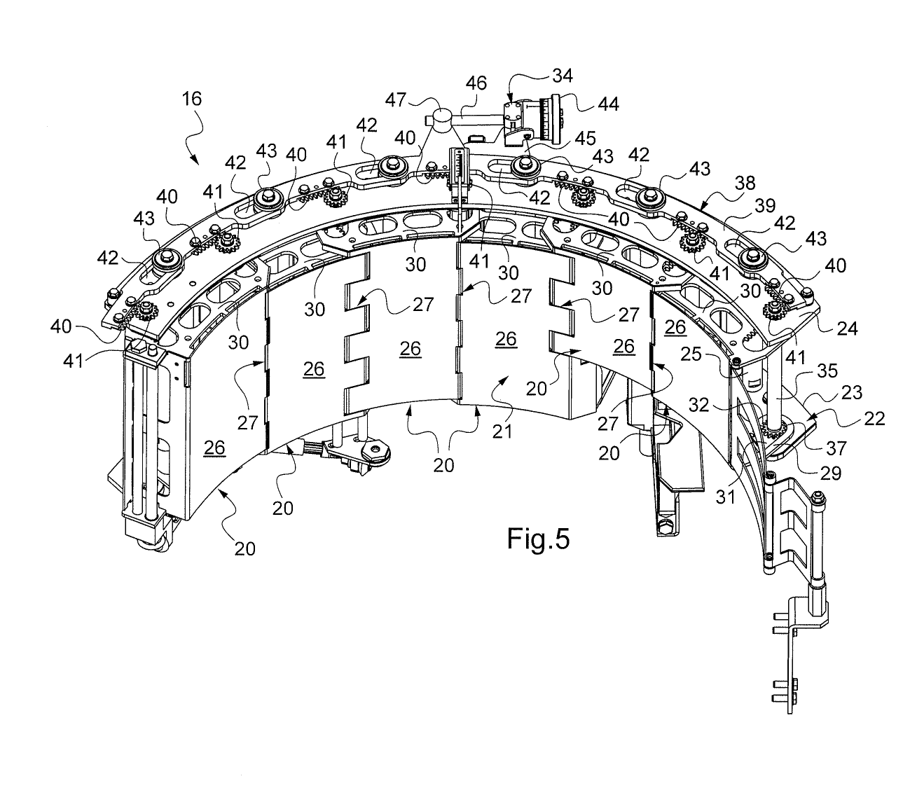

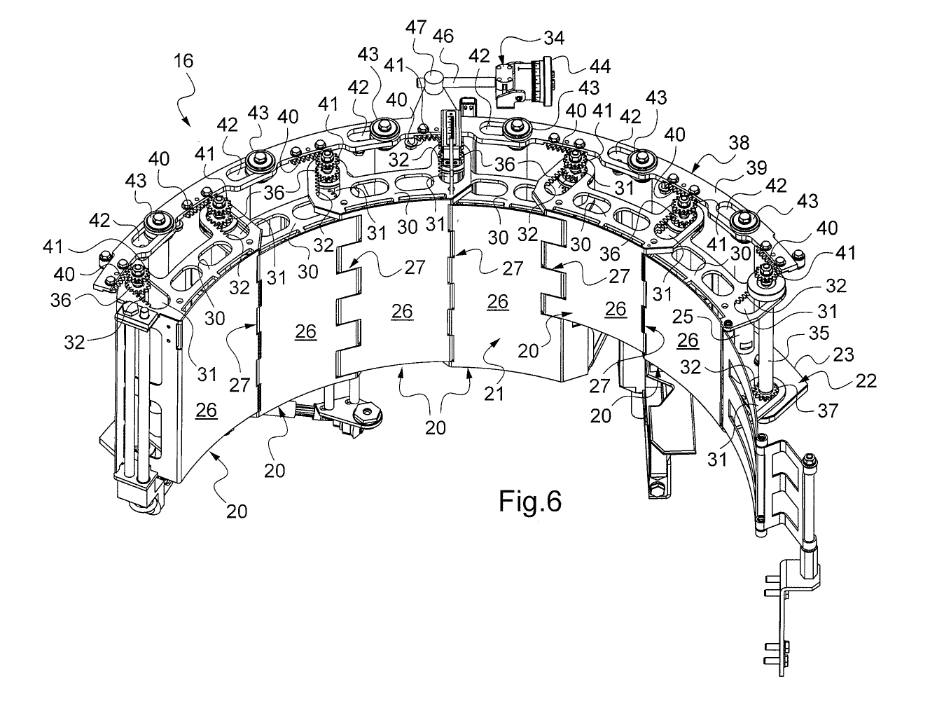

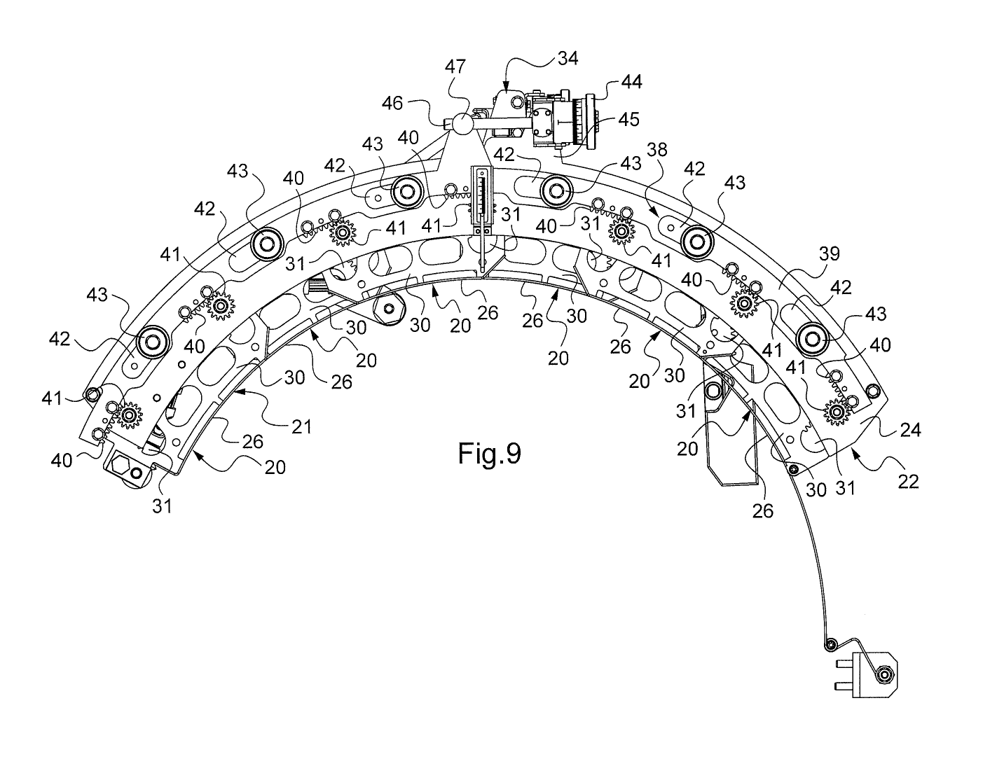

The adjustable curved guide 16 will now be disclosed with particular reference to FIG. 5-10.

The adjustable curved guide 16 includes a series of guiding segments 20 located adjacent to each other to form a substantially cylindrical wall 21 against which the containers 5 abut and slide during their circular movement along the transfer path 6. In order to adapt the curved guide 16 to the container format, i.e. to the container body diameter, radius of the cylindrical wall 21 is adjustable by radial movement of the guiding segments 20 forth or back for, respectively, decreasing or increasing the radius.

As depicted on FIG. 5, the curved guide 16 comprises a fixed frame 22 including two spaced apart arcuate plates 23, 24, namely a lower plate 23 and an upper plate 24, with respect of which the guiding segments 20 are slidingly mounted with radial travel, and fixed to each other by means of cylindrical spacers 25.

Each guiding segment 20 comprises a cylindrical panel 26 including, at lateral edges thereof, crenellations 27 by which two adjacent guiding segments 20 overlap to ensure continuity of the cylindrical wall 21 whichever the radius. Height of the cylindrical panel 26 preferably corresponds to the largest available container height, in order to distribute stress and maintain verticality of the containers 5 whichever their format.

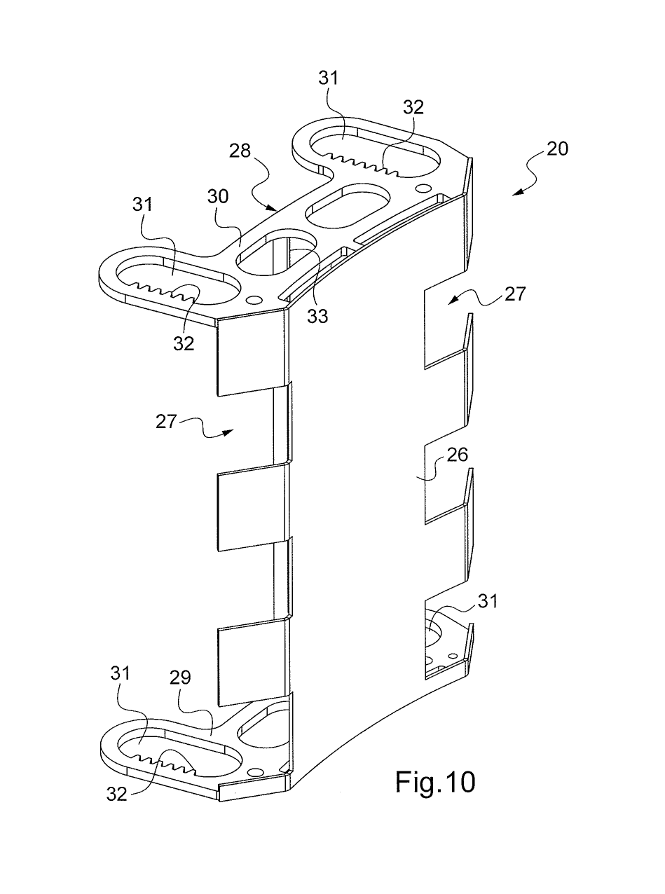

The cylindrical panel 26 is fixed to a mount 28 comprising two spaced apart flanges 29, 30, namely a lower flange 29 and an upper flange 30, located respectively behind a lower end of the panel 26 and behind an upper end thereof, each of which includes a pair of elongated slots 31 extending substantially radially (i.e. perpendicular with respect of the cylindrical panel) and each provided with a rack 32, as detailed on FIG. 10. A scale-shaped stiffener 33 is interposed between the flanges 29, 30 and the cylindrical panel 26, in order to provide rigidity to the guiding segment 20.

The curved guide 19 further comprises an adjustment mechanism 34 for radially moving the guiding segments 20 forth or back to adapt the radius of the cylindrical wall 21 to the container format, in other words to narrow or widen the annular space 6 between the curved guide 16 and the star wheel 11 according to a predetermined container diameter.

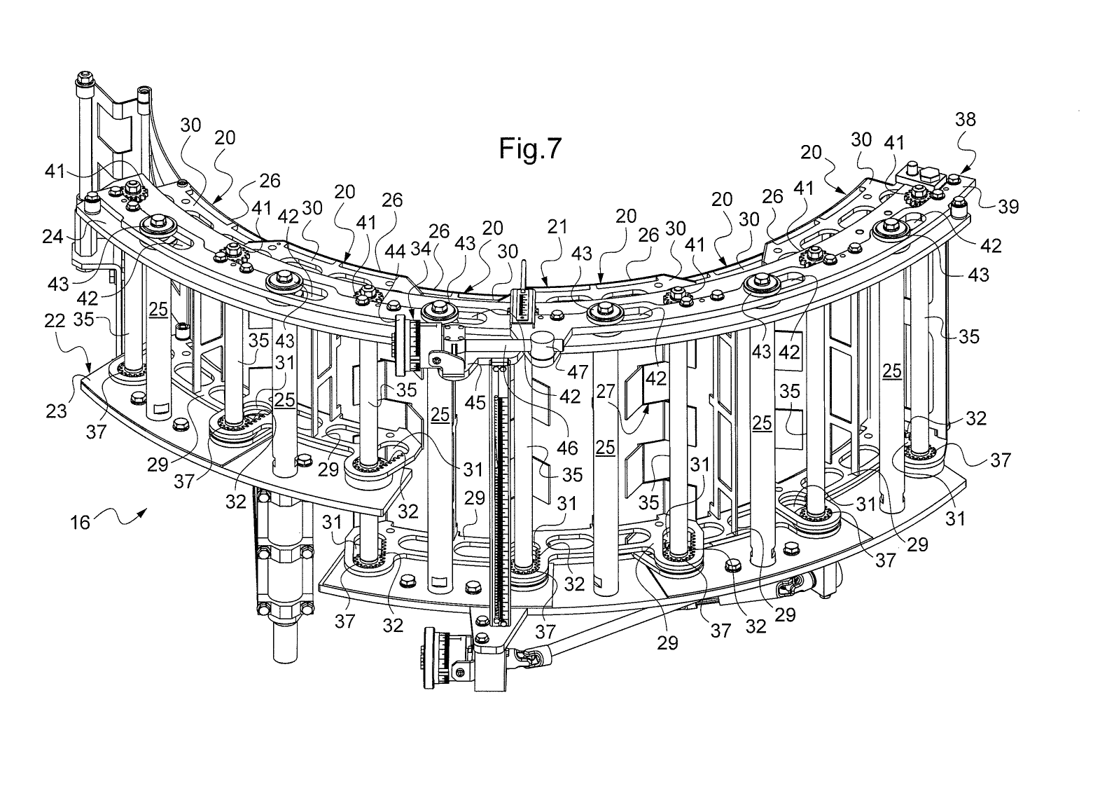

The adjustment mechanism 35 includes a plurality of posts 35 pivotally mounted with respect of the plates 23, 24, as depicted on FIG. 7. Each post 35 is provided, at an upper end, with an upper pinion 36 located in an elongated slot 31 of an upper flange 30 of a guiding segment 20, and engaging the rack 32 thereof. At a lower end, the post 35 is provided with a lower pinion 37 located in an elongated slot 31 of the corresponding lower flange 29 of the guiding segment 20, and engaging the rack 32 thereof. Accordingly, by means of these rack-and-pinion gears 32/36 and 32/37, rotation of the posts 35 moves the guiding segments 20 radially forth or back, depending upon the direction of rotation of the posts 35.

Where two adjacent guiding segments 20 overlap, their flanges 29, 30 are superposed in such a way that a common pinion 36, respectively 37, engages simultaneously their respective racks 32, whereby rotation of the post 35 moves both guiding segments 20 radially. The slots 31 of two adjacent guiding segments 20 diverge slightly with respect of a radial direction, so that in their radial movement the segments 20 move tangentially away from or towards each other when adjusted to increase or, respectively, decrease the radius of the curved guide 19.

In order to ensure synchronized movement of the guiding segments 20, the adjustment mechanism 34 includes a distribution mechanism 38 comprising an arcuate rack plate 39 slidingly mounted on the upper plate 24 and including a series of spaced apart indentations 40 each engaging a follower pinion 41 provided at an upper end of a rotatable post 35, above the upper pinion 36.

The rack plate 39 comprises a series of elongated slots 42 in which upper ends 43 of the cylindrical spacers 25 are engaged, thereby both guiding and limiting rotational movement of the rack plate 39.

As depicted on FIG. 5-9, the adjustment mechanism 34 comprises a manually operable handwheel 44, pivotally mounted on a radial protrusion 45 of the upper plate 24. The handwheel 44 is pivotally coupled to a screw 46 engaging a nut 47 mounted on a radial protrusion of the rack plate 39, whereby rotation of the handwheel 44 moves the rack plate 39 with respect of the upper plate 24.

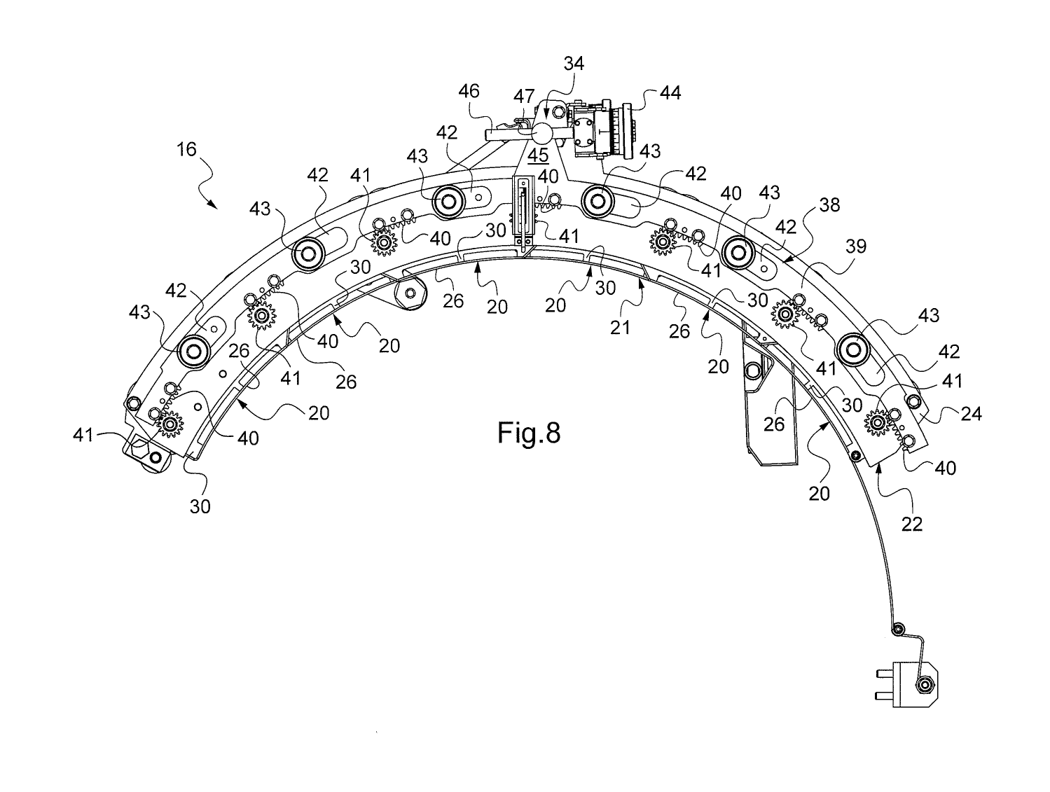

More precisely, starting from the configuration of FIG. 8, wherein the curved guide 16 is adjusted to a large container format, i.e. radius of the cylindrical wall 21 is set to a larger value, rotation of the handwheel 44 counterclockwise moves the rack plate 39 counterclockwise (from a top point of view) with respect of the upper plate 24. As it moves, the rack plate 39 rotates the posts 35 via the circumferential rack-and-pinion gears 40/41, thereby moving the guiding segments 20 inwardly via the radial rack-and-pinion gears 31/36 and 32/38, whereby radius of the cylindrical wall 21 is set to a smaller container format.

Accordingly, in a single movement, rotation of the sole handwheel 44 provides smooth adjustment of all guiding segments 20 simultaneously, via the distribution mechanism 38 which synchronizes movement thereof.

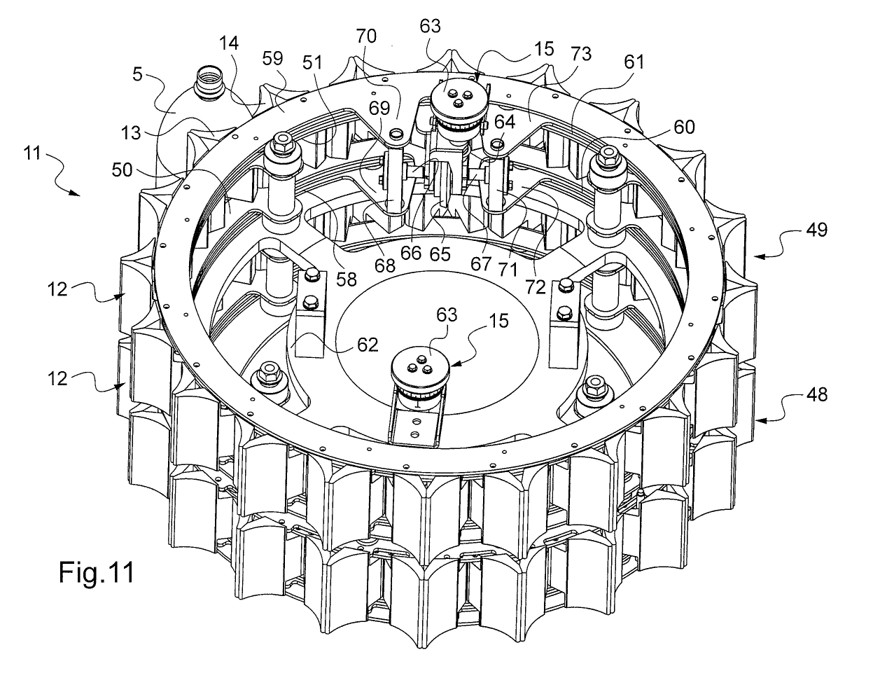

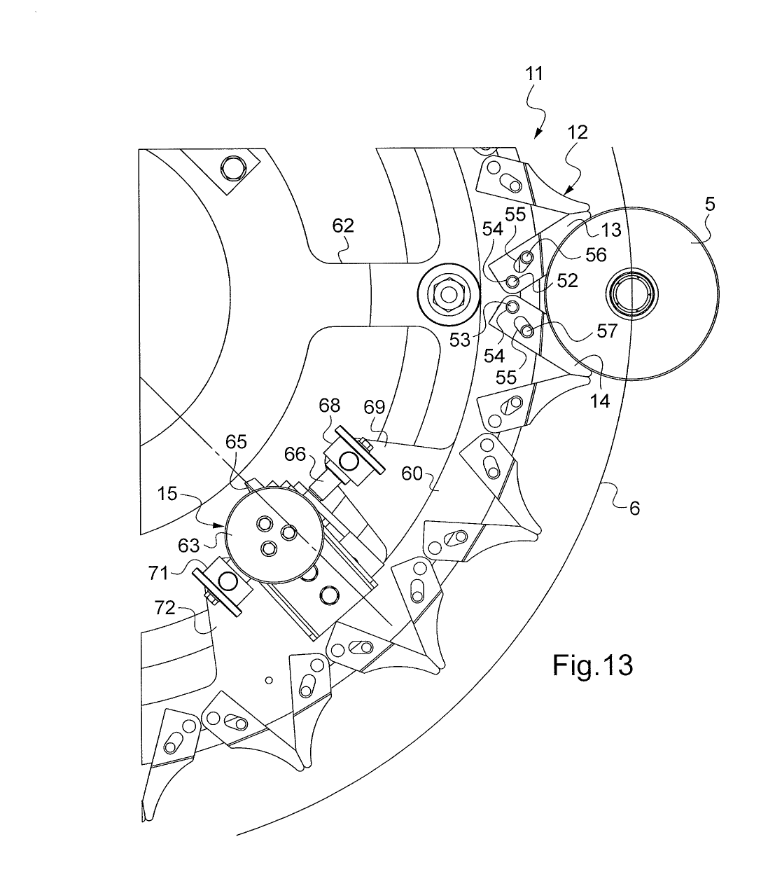

The adjustable star wheel 11 will now be disclosed with particular reference to FIG. 11-15.

As depicted on FIG. 11, the star wheel 11 comprises two superposed stages 48, 49 each provided at its periphery with a plurality of movable container body grippers 12, which permit vertical movement of the containers 5 during transfer along the path 6. Accordingly, the star wheel 11 is adapted to engage and displace a plurality of containers 5 whichever their height.

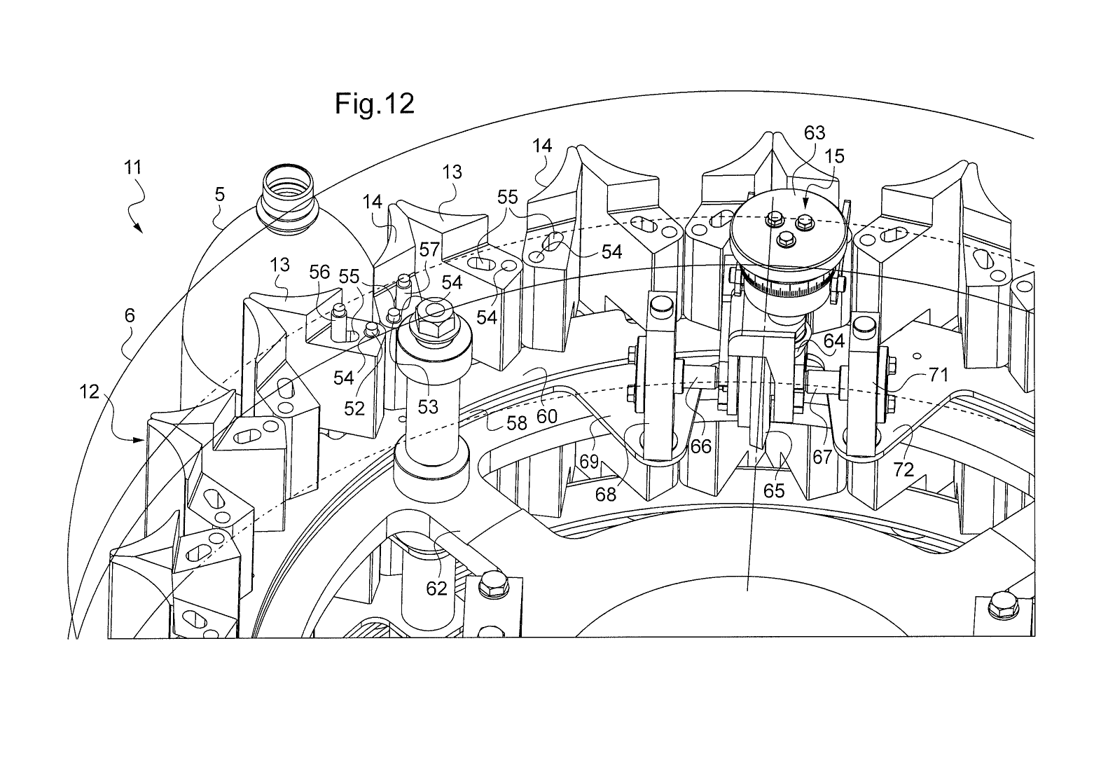

As depicted on FIG. 12, each body gripper 12 comprises a pair of wings 13, 14, i.e. a left wing 13 and a right wing 14 pivotally mounted between a lower support plate 50 and an upper support plate 51 about a pair of respective rotation axis 52, 53 fixed at both ends to the plates 50, 51.

Each wing 13, 14 is provided with a cylindrical bore 54 wherein the rotation axis 52, 53 is inserted, and an elongated slot 55 wherein a post 56, 57 is received with sliding travel.

The post 56 of the left wing 13 is mounted between a pair of spaced primary annular plates 58, 59, i.e. a lower primary plate 58 and an upper primary plate 59, whereas the post 57 of the right wing 14 is mounted between a pair of spaced secondary annular plates 60, 61 superposed to the primary plates 58, 59, i.e. a lower secondary plate 60 located above the lower primary plate 58 (with interposition of a series of spacers), and an upper secondary plate 61 located under the upper primary plate 59 (with interposition of a series of spacers), as depicted on FIG. 11.

Both pairs of plates 58 and 59; 60 and 61 are mounted with angular travel onto a star wheel frame 62. The star wheel 11 further includes an adjustment mechanism 15 including a manually operable handwheel 63 pivotally mounted on the star wheel frame 62. The handwheel 63 is coupled in rotation to a conical driving pinion 64 which engages at 90° a conical driven gear 65. The gear 65 is coupled in rotation to a pair of opposed screws 66, 67, i.e. a right-hand threaded primary screw 66 engaging a primary nut 68 pivotally mounted between a pair of superposed radial protrusions 69, 70 of the primary plates 58, 59, and a left-hand threaded secondary screw 67 engaging a secondary nut 71 pivotally mounted between a pair of superposed radial protrusions 72, 73 of the secondary plates 60, 61, whereby rotation of the handwheel 63 drives with angular motion and in synchronism the two pairs of plates 58 and 59; 60 and 61 in opposed directions.

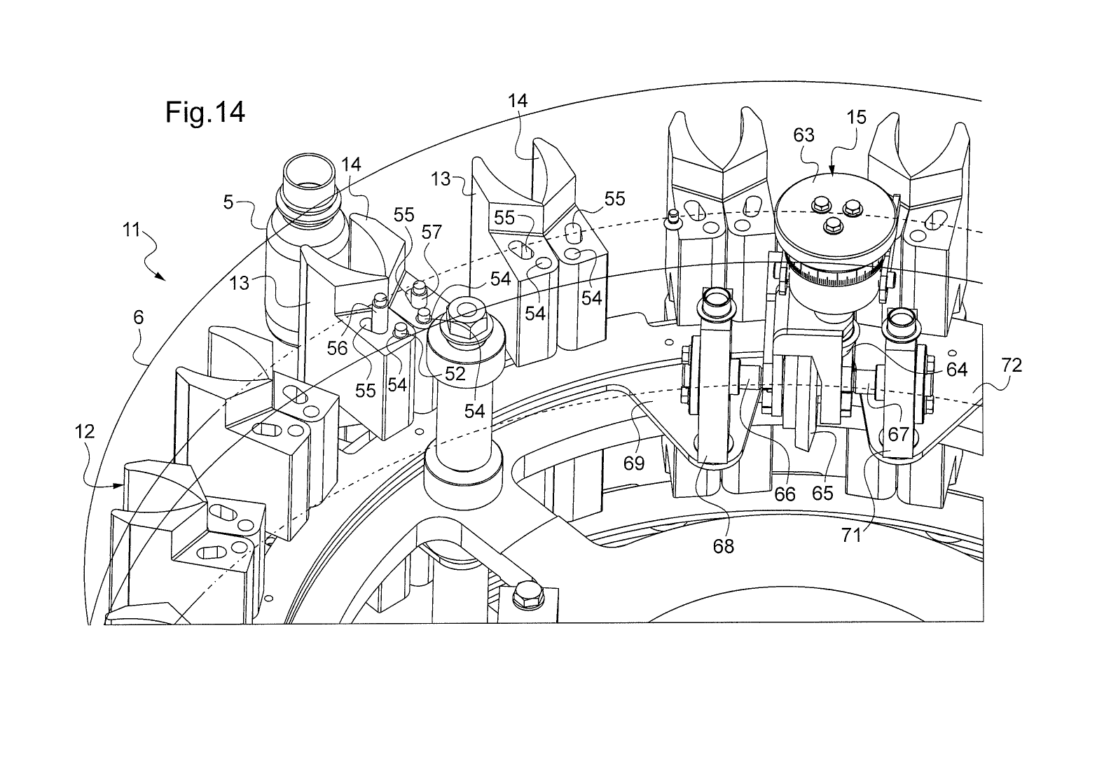

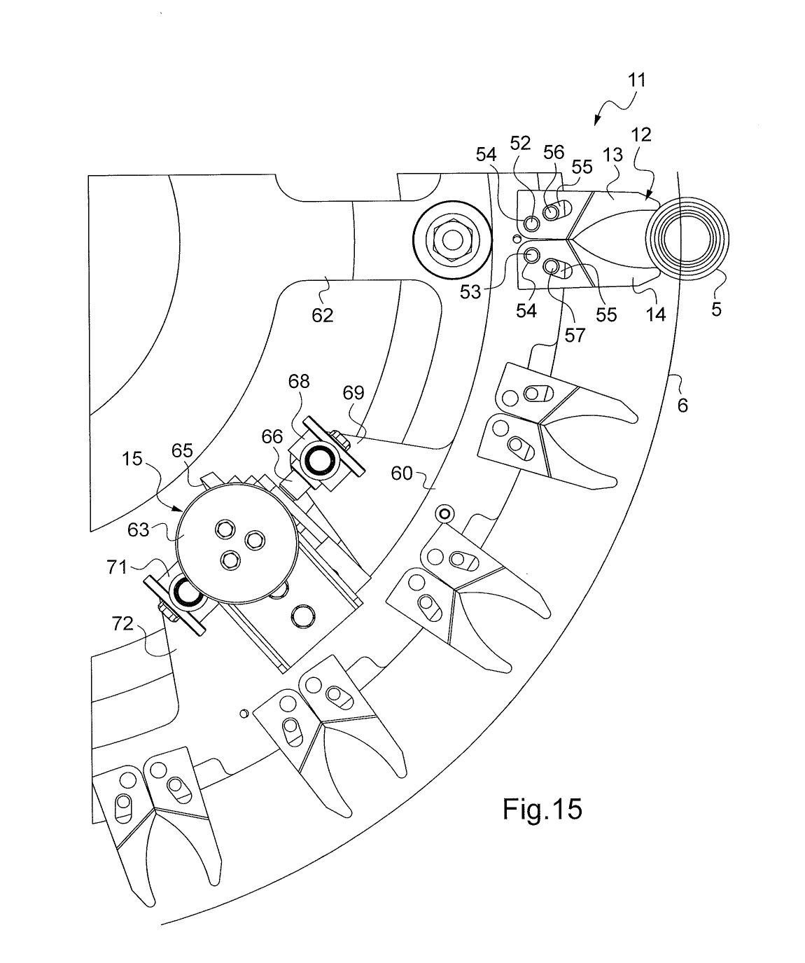

More precisely, starting from the configuration of FIG. 12, wherein the star wheel 11 is adjusted to a large container format, i.e. the body grippers 12 are set to a wide open position, rotation of the handwheel 63 clockwise drives, via the pinion 64, the gear 65 and the screws 66, 67 in rotation clockwise, thereby moving the pairs of superposed radial protrusions 69 and 70; 72 and 73 towards each other. As they rotate, the plates 58-61 drive the posts 56, 57 of each pair of wings 13, 14 towards each other. The posts 56, 57 slide within their respective slots 55, forcing the wings 13, 14 to pivot about their axis 52, 53 towards each other towards a narrow open position adapted to a small container format, as depicted on FIG. 14-15.

As illustrated on FIG. 12 and FIG. 14, the handwheel 63 is preferably provided with a circular graduation in order to precisely adjust the star wheel 11 to a predetermined configuration.

Accordingly, in a single movement, rotation of the sole handwheel 63 provides smooth adjustment of all body grippers 12 simultaneously.

As the star wheel 11 includes two stages, namely a lower stage 48 and an upper stage 49 (see FIG. 11), it comprises a pair of diametrically opposed similar adjustment mechanisms 15 for setting respectively the lower stage 48 and the upper stage 49 to a predetermined container format. Graduations on the handwheels 63 help setting the stages 48, 49 with great precision to the same container format.

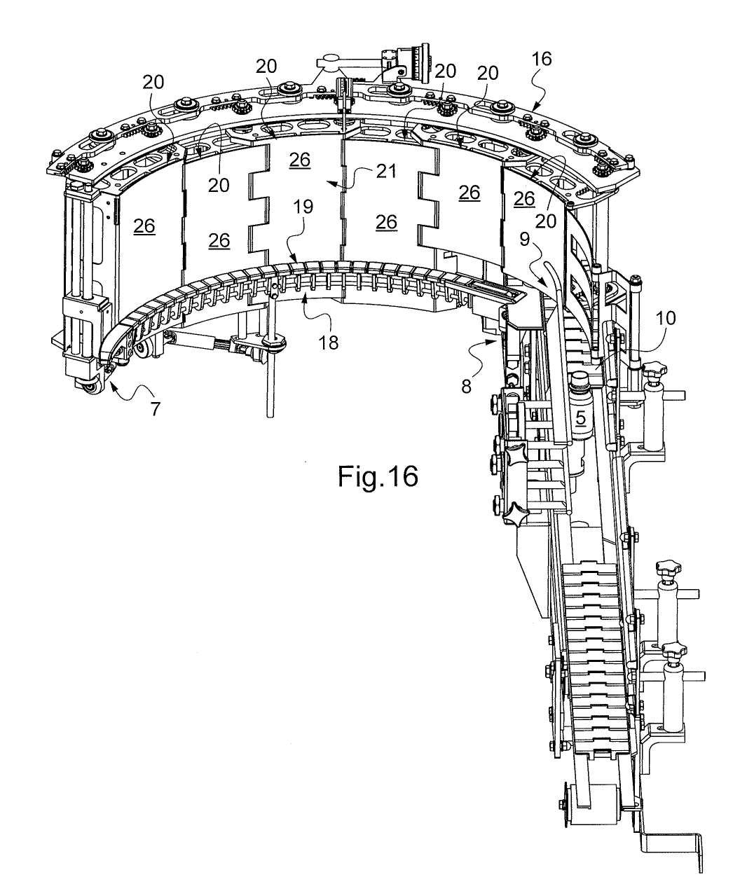

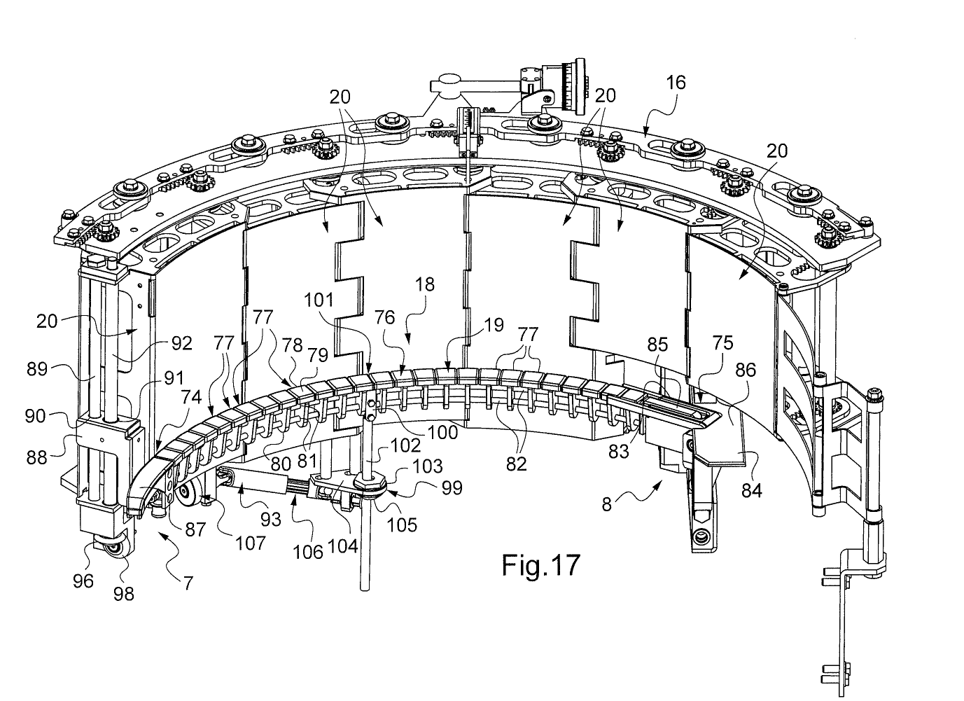

The container support device 18 will now be disclosed with particular reference to FIG. 16-19.

The container support device 18 comprises an adjustable curved bridge 19 extending substantially parallel to the cylindrical wall 21 of the curved guide 16 from the loading point 7, at a proximal end 74 of the bridge 19, to the discharge point 8, at a distal end 75 of the bridge 19.

The bridge 19 comprises a flexible chain deck 76 including a series of adjacent chain links 77 each having a top pad 78 with a flat upper surface 79, and a base 80 protruding downwards perpendicularly from the pad 78. The base 80 of each link 77 includes a pair of superposed through holes 81 for passage of a pair of superposed flexible shanks 82.

At its distal end, the bridge 19 comprises a discharge ramp 83, to which the flexible shanks 82 are fixed, hinged to a fixed frame 84 of the discharge conveyor 10 in such a way that an upper surface 85 of the discharge ramp 83 is substantially continuous with an upper surface 86 of the frame 84.

At its proximal end, the bridge 19 comprises a loading ramp 87 to which the flexible shanks 82 are fixed, located at the junction between the carrousel 3 and the container transfer device 4. The loading ramp 87 is fixed to an elevator device 88 slidingly mounted with vertical axial travel onto a post 89 attached to the guiding segment 20 located at a proximal end of the curved guide 16. The elevator device 88 is provided with a through hole 90 for sliding passage of the post 89, and with a threaded hole 91 adjacent the through hole 90, engaging a vertical threaded rod 92 pivotally mounted to the same guiding segment 20 as the post 89, adjacent thereto.

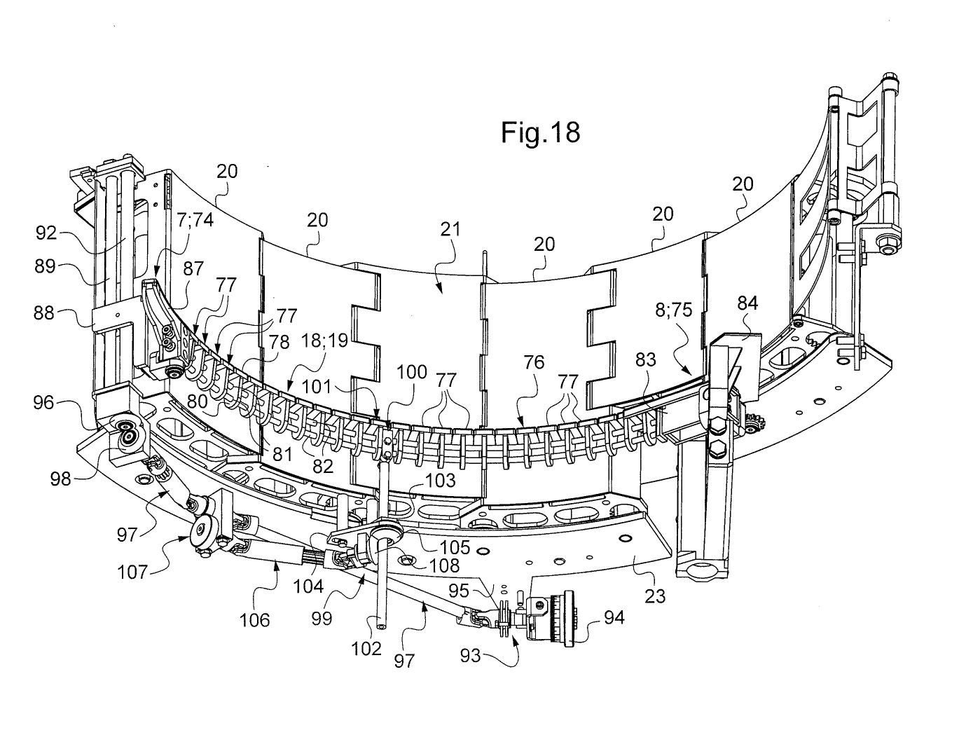

As depicted on FIG. 18, the container transfer device 4 includes an adjustment mechanism 93 for setting the height of the proximal end 74 of the bridge 19, depending upon the container format, and more precisely upon the height of the containers 5. The adjustment mechanism 93 comprises a handwheel 94 pivotally mounted on a radial protrusion 95 of the lower plate 23 of the curved guide 16. The handwheel 94 drives a pinion 96 fixed at a lower end of the threaded rod 92, through a primary cardan shaft assembly 97 pivotally mounted on the lower plate 23 and having, at a proximal end, a driving pinion 98 engaging at 90° the driven pinion 96.

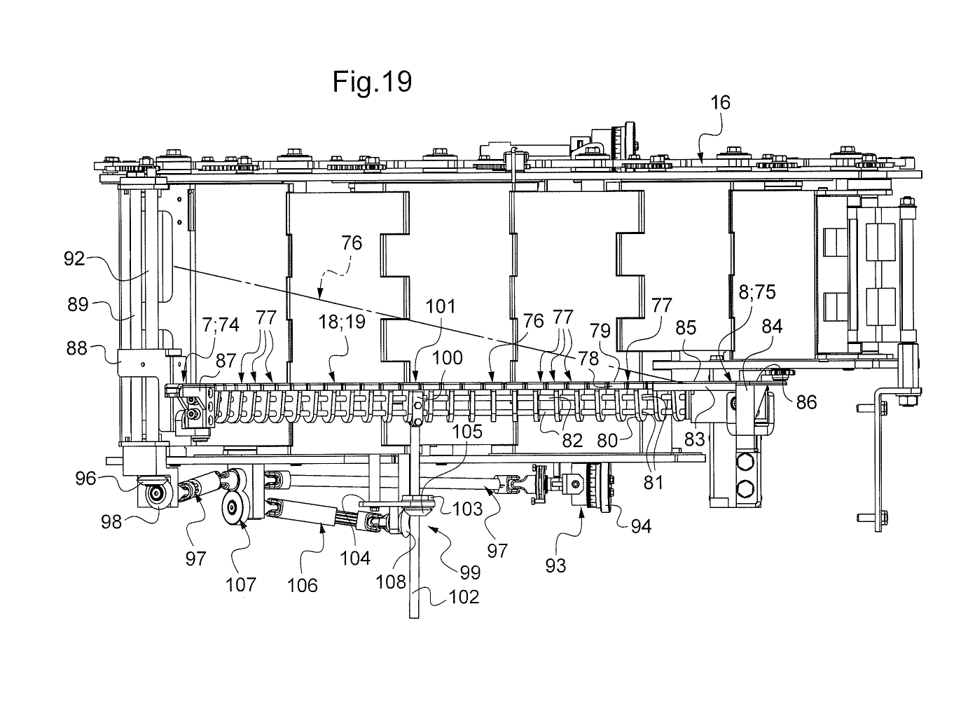

Adjustment of the bridge 19 is achieved by rotating the handwheel 94 in either direction, depending upon the target configuration. More precisely, starting from the configuration illustrated on FIG. 19, wherein the bridge 19 is in a substantially horizontal lower position adapted to a large container format, rotation of the handwheel 94 counterclockwise drives the pinion 96 (and hence the threaded rod 92) in rotation counterclockwise, thereby translating the elevator device 88 upwards, until the targeted configuration is reached, as illustrated by the inclined dashed line which represents the upper surface of the bridge 19. As the shanks 80 are made of a flexible material, they bend upwards during adjustment, until appropriate configuration is reached.

As depicted on FIG. 18 and FIG. 19, the adjustment mechanism 93 further comprises an adjustable intermediate support device 99 including a movable bracket 100 fixed to an intermediate portion 101 of the bridge 19. The bracket 100 is mounted at an upper end of a threaded rod 102 engaging a nut 103 fixed to a flange 104 attached to an intermediate guiding segment 20 and provided at a lower end with a driven pinion 105. The support device 99 is adjusted in height in synchronism with the elevator device 88 through a secondary cardan shaft assembly 106 coupled in rotation to the primary cardan shaft assembly 97 through a gear assembly 107 and having at a distal end a driving pinion 108 engaging the driven pinion 105. The gear assembly 107 has a reduction rate such that the height of the support device 99 is a constant fraction of the height of the elevator device 88, whichever the configuration. Accordingly, counterclockwise rotation of the handwheel 94 drives the pinion 108 in rotation clockwise through the primary cardan shaft assembly 97, the gear assembly 107 and the secondary cardan shaft assembly 104, thereby rotating the driven pinion 105 counterclockwise, hence translating the threaded rod 102 and the bracket 100 upwards and setting the intermediate portion of the bridge 19 to the targeted height.

Accordingly, the adjustable container support device 18 provides adaptability of the container transfer device 4 to the container height. In other words, whichever their format, the containers 5 are slidingly supported by their bottom during their circular motion along the transfer path 6.

In addition, as the proximal end 74 and the intermediate portion 101 of the bridge 19 are attached to guiding segments 20 of the curved guide 16, radius of the bridge 19 follows the radius of the curved guide 16 when adjusted, thereby adapting to the container diameter.

1. Adjustable device for transferring containers along an arc-of-a-circle path from a loading point to a discharge point, comprising an adjustable curved guide including a series of guiding segments located adjacent to each other, and an adjustment mechanism for radially moving said guiding segments forth or back to set a radius of the curved guide to a predetermined container diameter, characterized in that the adjustment mechanism comprises a distribution mechanism for synchronizing movement of the guiding segments.

2. Adjustable transfer device according to claim 1, wherein the distribution mechanism comprises an arcuate rack plate pivotally mounted with respect of a frame of the curved guide, and engaging a series of pinions coupled to the guiding segments.

3. Adjustable transfer device according to claim 2, wherein the guiding segments comprise at least one flange including an elongated slot provided with a rack engaged by a pinion.

4. Adjustable transfer device according to claim 3, wherein the guiding segments comprise a pair of spaced apart flanges each including elongated slots provided with racks engaged by pinions provided at both ends of posts pivotally mounted to a frame of the curved guide.

5. Adjustable transfer device according to claim 3, wherein each flange includes a pair of slots each provided with a rack.

6. Adjustable transfer device according to claim 3, wherein the flanges of two adjacent guiding segments overlap, in such a way that a common pinion engages simultaneously their respective racks.

7. Adjustable transfer device according to claim 2, wherein the rack plate comprises a series of elongated slots in which upper ends of cylindrical spacers are engaged, in order to guide rotational movement of the rack plate.

8. Adjustable transfer device according to claim 2, wherein the adjustment mechanism comprises a manually operable handwheel, pivotally mounted on the frame and pivotally coupled to a screw engaging a nut mounted on the rack plate, whereby rotation of the handwheel moves the rack plate with respect of the frame.

9. Adjustable transfer device according to claim 1, wherein the curved guide comprises a cylindrical wall, radius of which is adjustable to the container format.

10. Adjustable transfer device according to claim 9, wherein each guiding segment includes a cylindrical panel as part of the cylindrical wall.

11. Adjustable transfer device according to claim 10, wherein the cylindrical panels of adjacent guiding segments are crenellated and overlap.

12. Adjustable transfer device according to claim 10, wherein the cylindrical panel has a height corresponding to a largest available container height.
